(19) United States
(12) Patent Application Publication
(10) Pub. No.: US 2014/0036102 A1
(43) Pub. Date: Feb. 6, 2014

(54) IMAGE CAPTURE DEVICE AND METHOD FOR IMAGE PROCESSING BY VOICE RECOGNITION

(71) Applicant: HiTi Digital, Inc., New Taipei City (TW)

(72) Inventor: Yu-Fan Fang, New Taipei City (TW)

(73) Assignee: HiTi Digital, Inc., New Taipei City (TW)

(21) Appl. No.: 13/958,569

(22) Filed: Aug. 4, 2013

Related U.S. Application Data
(60) Provisional application No. 61/679,777, filed on Aug. 5, 2012.

(30) Foreign Application Priority Data
Jul. 30, 2013 (TW) 102127336

(51) Int. Cl. H04N 5/232

(52) U.S. Cl. CPC H04N 5/23203
USPC 348/211.4

(57) ABSTRACT

An image capture device includes a memory module, an image capture module, a voice recognition module, and a controller. The memory module stores a plurality of image effects. The image capture module is used to generate a captured image and store the captured image in the memory module.

The voice recognition module is used to receive a voice signal. The controller is electrically connected to the memory module, the image capture module, and the voice recognition module. The controller parses the voice signal via the voice recognition module. Then the controller is connected to the memory module to searches corresponding image effects according to a parsed result, and the controller selects one desired image effects from the corresponding image effects. Then the controller is connected to the memory module to select the captured image, and the controller synthesizes the selected image effect with the captured image.

### RELATED APPLICATIONS

This application claims priority to U.S. Provisional Application Ser. No. 61/679,777, filed Aug. 5, 2012 and Taiwan Application Serial Number 102127336, filed Jul. 30, 2013, which are herein incorporated by reference.

### BACKGROUND

1. Field of Invention

The present invention relates to an image capture device. More particularly, the present invention relates to an image capture device using voice control technique.

2. Description of Related Art

In additional to the basic photographing function, most conventional digital cameras and phones with cameras have effect editors as well, for image post-processing, such as transforming images into grayscale mode or vintage mode or add a variety of frames, decorative pictures, or graffiti texts to the images, so as to create unique photos and to show personal styles.

When using the conventional effect editors, a user must select a favored effect from a series of options shown on the display, which is hard for the user to find out the favored effect from a large database, such that the operation process is cumbersome. In situations such as traveling or gathering, such operation process will become inappropriate. Therefore, how to design a method and associated products, which enhances search efficiency, such that the user finds out the flavored effects and post-processes images quickly, is one development goal of camera industry.

In addition, if digital cameras or phones with cameras are used with recently developed instant mobile printers, users can carry these devices, and they can photograph and print photos immediately after photographing in situations such as traveling or gathering while the process from photographing to printing will become more complex. Therefore, for providing the best user experience, reducing the cumbersome operation process will become more important.

### SUMMARY

This disclosure provides an image capture device to reduce an operation process by using voice recognition to post-process images. In one embodiment, an image capture device is provided. An image capture device includes a memory module, an image capture module, a voice recognition module, and a controller. The memory module stores a plurality of image effects. The image capture module is used to capture and generate a captured image and then store the captured image in the memory module. The voice recognition module is used to receive a voice signal. The controller is electrically connected to the memory module, the image capture module, and the voice recognition module. The controller parses the voice signal via the voice recognition module. Then the controller is connected to the memory module to searches at least one of the image effects according to a parsed result, and the controller selects a desired one of the image effects from the at least one of the image effects. Then the controller is connected to the memory module to select the captured image, and the controller synthesizes the selected image effect with the captured image.

In one or more embodiments, the controller synthesizes the selected image effect with the captured image by layer overlay.

In one or more embodiments, the controller synthesizes the selected image effect with the captured image by labeling the selected image effect as a special mark in the captured image, thereby forming a synthesized image.

In another embodiment, an image processing system is provided. The image processing system includes the aforementioned image capture device and an image output device. When the image capture device instructs the image output device to output the synthesized image, the image output device outputs a synthesized picture, in which the synthesized picture includes a picture base printed according to the captured image and a picture effect printed according to the special mark.

In another embodiment, a method for image processing by voice recognition is provided. The method for image processing by voice recognition includes: receiving a voice signal by a voice recognition module; parsing the voice signal by the voice recognition module and a controller; connecting the controller to a memory module and searching at least one of image effects according to a parsed result by the controller; selecting a desired image effect from the at least one of the image effects; connecting the controller to the memory module and selecting at least one captured image by the controller; and synthesizing the selected image effect with the selected captured image by the controller.

In one or more embodiments, the controller synthesizes the selected image effect with the selected captured image by layer overlay.

In one or more embodiments, the controller synthesizes the selected image effect with the selected captured image by labeling the selected image effect as a special mark in the captured image, thereby forming a synthesized image.

In one or more embodiments, the method for image processing by voice recognition further includes: providing an image output device, and when the image capture device instructs the image output device to output the synthesized image, the image output device outputs a synthesized picture, in which the synthesized picture includes a picture base printed according to the captured image and a picture effect printed according to the special mark.

In one or more embodiments, the color of the picture effect is a metallic color.

By integrating voice recognition and the image capture device, users can easily post-process images after taking pictures in situations such as traveling or gathering. In addition, when the image capture device is used with an instant mobile printer, in which the process from photographing to printing photos becomes more complex, the image capture device still provides the best user experience by reducing the cumbersome operation process.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of an image capture device according to one embodiment of this invention;

FIG. 2 is a flow chart of a method for image processing by voice recognition according to one embodiment of this invention;

FIG. 3 is a block diagram of the image capture device according to another embodiment of this invention; and

FIG. 4 is a flow chart of the method for image processing by voice recognition according to another embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

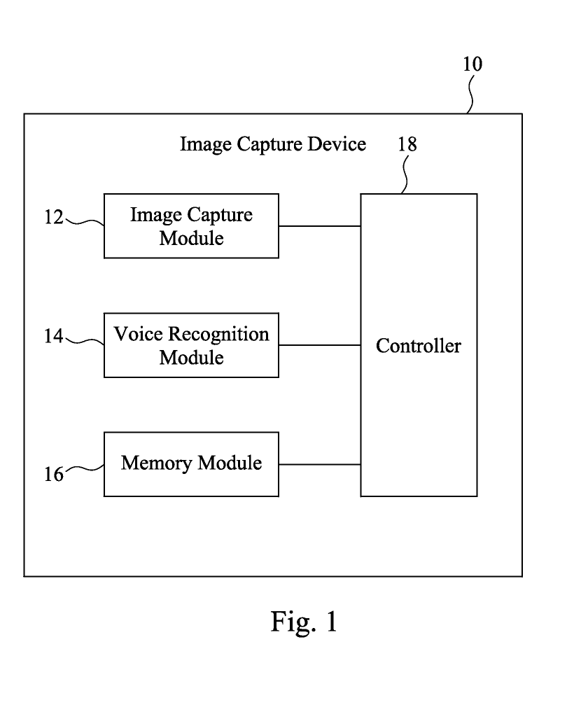

FIG. 1 is a block diagram of an image capture device according to one embodiment of this invention. An image capture device 10 is provided. The image capture device 10 can be a digital camera or a camera on a cell phone. In other words, the image capture device 10 can be an image capture device with electronic information processing ability, and the image capture device 10 can be a mobile device.

As shown in FIG. 1, the image capture device 10 includes an image capture module 12, a voice recognition module 14, a memory module 16, and a controller 18. The memory module 16 stores a plurality of image effects. The image capture module 12 is used to capture and generate a captured image and then store the captured image in the memory module 16. The voice recognition module 14 is used to receive a voice signal. The controller 18 is electrically connected to the memory module 16, the image capture module 12, and the voice recognition module 14. The controller 18 parses the voice signal via the voice recognition module 14. Then the controller 18 is connected to the memory module 16 to searches at least one of the image effects according to a parsed result, and the controller 18 selects a desired one of the image effects from the at least one of the image effects. Then the controller 18 is connected to the memory module 16 to select the captured image, and the controller 18 synthesizes the selected image effect with the captured image.

The image capture device 10 can further include a display module, an input module, and an information transmission/reception module. The display module is used to display information provided by the image capture device 10 to users, such as images, photos, or text messages. The display module can be an LCD (liquid-crystal display). The input module is used for users to input commands. The input module can be a keyboard or a touchscreen. The information transmission/reception module is used to output captured images or post-processed images or receive information such as a firmware update. The information transmission/reception module can be a wired module, such as a USB (Universal Serial Bus) module, or a wireless module, such as a bluetooth module or a radio modem.

The image capture module 12 can include lens, a shutter, a body, and a sensor. The detailed structure of the configuration will not be described here. The sensor can be a CCD (charge-coupled device) or a CMOS (complementary metal-oxide-semiconductor). The captured image can be photos or electronic images.

The voice recognition module 14 can include a receptor. The receptor is used to receive voice signals from external environment, and the receptor can optionally filter (filter out noises) and resolve (zoom main signals) the voice signals. For example, by a determination rule, the voice recognition module 14 determines which part of a voice signal is noises and filter out the noises. Then the voice recognition module 14 zoom the main signal. The above steps can be repeated several times. By the above function, commands in the voice signals can be recognized. The voice recognition module 14 can be hardware or firmware. The receptor can be a microphone.

The memory module 16 can be a RAM (random-access memory). People having ordinal skill in the art can make proper modification to the memory module 16 according to their actual needs.

The image effect stored in the memory module 16 can be used to post-process the captured image. Specifically, the image effect includes color conversion, such as grayscale mode, vintage mode, negative mode, exposure mode, and color separation mode, etc., and adding a frame, decorative pictures, or graffiti texts to the image. The image effect is not limited by the aforementioned examples, and the details are not described here. The memory module 16 can build in a series of image effects, optionally save new image effects via external memories, or optionally download updated image effects via the Internet. Sources of image effects are not limited by the aforementioned methods, depending on design requirements.

The controller 18 can be a CPU (central processing unit) or an application processor. People having ordinal skill in the art can make proper modification to the controller 18 according to their actual needs.

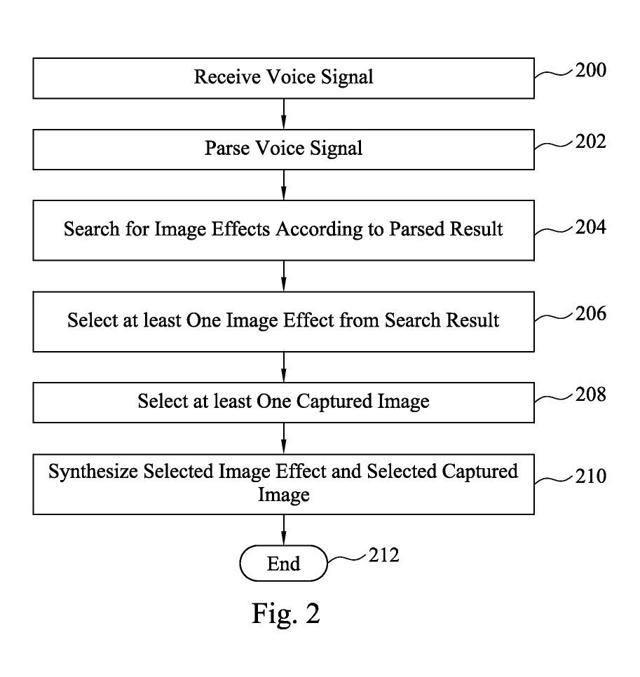

FIG. 2 is a flow chart of a method for image processing by voice recognition according to one embodiment of this invention. A method for image processing by voice recognition is provided, and the method is used by the image capture device 10. The operation steps are described in the followings. Step 200 is receiving a voice signal by the voice recognition module 14. The voice recognition module 14 can receive voice signals from external environment by the receptor, and the receive function can be triggered by a mechanism. For example, the input module inputs a specific command, or the action that a captured image is captured by the image capture module 12 and then stored in the memory module 16 is finished.

Step 202 is parsing the voice signal by the voice recognition module 14 and the controller 18. Specifically, after the voice recognition module 14 receives the voice signal, the voice recognition 14 can optionally filter and resolve the voice signal and obtain the main signal, and then the controller 18 determines the main signal as a specific command and takes the command as a parsed result. For example, when a user says “heart”, the voice recognition 14 first filter out noises and zoom the voice signal “heart”, and then the controller 18 determines the voice signal “heart” as the command “heart”.

Step 204 is connecting the controller 18 to the memory module 16 and searching at least one of image effects according to the parsed result by the controller 18. For example, when the parsed result is command “heart”, the controller 18 connects to the memory module 16 and searches for image effects associated to “heart”, such as “heart” represented by characters or a heart icon, and then the controller 18 shows the image effects as a list on the display module.

Step 206 is selecting a desired image effect from the at least one of the image effects. For example, when the controller 18 shows the titles of the image effects of “heart” represented by characters and of a heart icon on the display module, the user can input commands via the voice recognition module 14 or the input module to select the desired image effect.

After the user selects the desired image effect, for some specific image effect, such as adding decorative pictures or graffiti texts to captured images, the user can input commands via the voice recognition module 14 or the input module. For example, the user can input a text message or adjust the position of an icon in a captured image, so as to complete the settings of the image effect.

The steps 202-206 can be repeated, so the user can select a plurality of desired image effects. For example, the user can add a graffiti text and a heart icon to a captured image simultaneously.

Step 208 is connecting the controller 18 to the memory module 16 and selecting at least one captured image by the controller 18. For example, the controller 18 can select a captured image that is just captured by the image capture module 12, or the controller 18 can select a captured image that was stored in the memory module 16 previously.

The step 210 is synthesizing the selected image effect with the selected captured image by the controller 18. There are many ways to synthesize the selected image effect and the selected captured image. Specifically, if the image effect is color conversion, the controller 18 can transform the color information of the captured image according to a color conversion formula. For example, if the image effect is grayscale mode, the controller 18 can remove the color information of the captured image and leave the brightness information. If the image effect is adding a decorative picture or a graffiti text to the captured image, the controller 18 can take the selected captured image as a base layer and take the selected image effect as an overlay layer, and then the controller 18 superimposes the overlay layer on the base layer and forms a synthesized image. Alternatively, The controller 18 can label the selected image effect as a special mark in the selected captured image, thereby forming the synthesized image.

The synthesized image formed by layer overlay is in image information format, so the synthesized image can be shown in image form on the display module. But the synthesized image formed by labeling the selected image effect as the special mark in the selected captured image is not totally in image information format, so not all information in the synthesized image can be shown in image form on the display module.

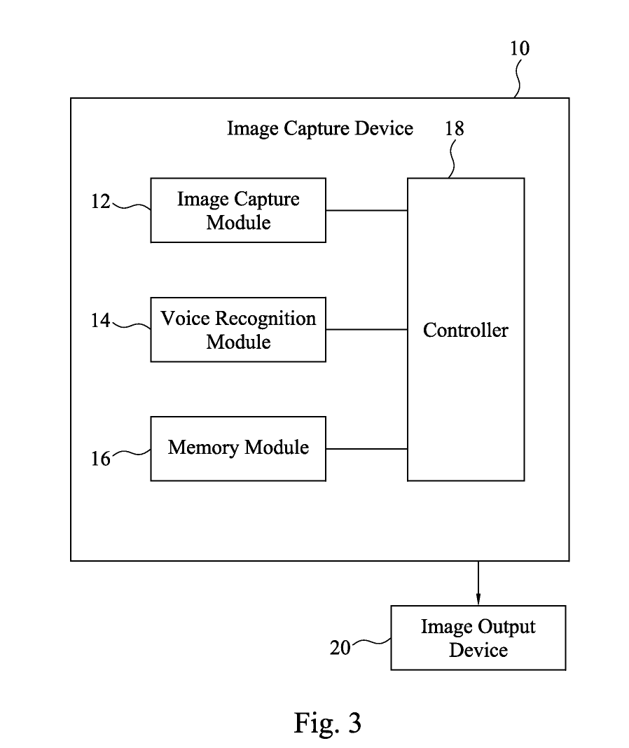

FIG. 3 is a block diagram of the image capture device according to another embodiment of this invention. The image capture device 10 can be used with an image output device 20, and the image capture device 10 instructs the image output device 20 by the information transmission/reception module. When the image capture device 10 instructs the image output device 20 to output the synthesized image, the image output device 20 outputs a synthesized picture. The synthesized picture includes a picture base printed according to the captured image and a picture effect printed according to the special mark. Image capture device 10 and the image output device 20 can be composed of an image processing system.

The image output device 20 can be a laser printer, an inkjet printer, a dye-sub printer or a mobile printer. When the image output device 20 is a mobile printer and when the user uses the image capture device 10 with the image output device 20, the user can follow the above embodiment, and from photographing, effect selection, photo post-processing, to photo printing, all steps can be completed at once. Because the image capture device 10 and the image output device 20 can both be mobile devices, the user can carry the two devices, and the user can photograph and print photos immediately after photographing in situations such as traveling or gathering, which brings the user a lot of fun. However, in the above situations, the process from photographing to printing photos seems to be very complex, so reducing the operation process by voice recognition will enhance the user experience a lot.

The color of the picture effect can be a metallic color, such as gold or silver, and a gold foil or a silver foil can be used as the print material to achieve the effect, which could bring more fun in the above situation. For example, a photo with a golden or silver heart icon will make the photo more attractive. Because gold and silver can not be presented by normal pixels, the display module can not show these colors, and normal electronic images can not present these colors as well. Therefore, when outputting the synthesized picture with gold or silver color, the image output device 20 does not output the synthesized picture according to the synthesized image formed by layer overlay; Instead, the image output device 20 prints the picture base according to the captured image and the picture effect according to the special mark, so as to output the synthesized picture.

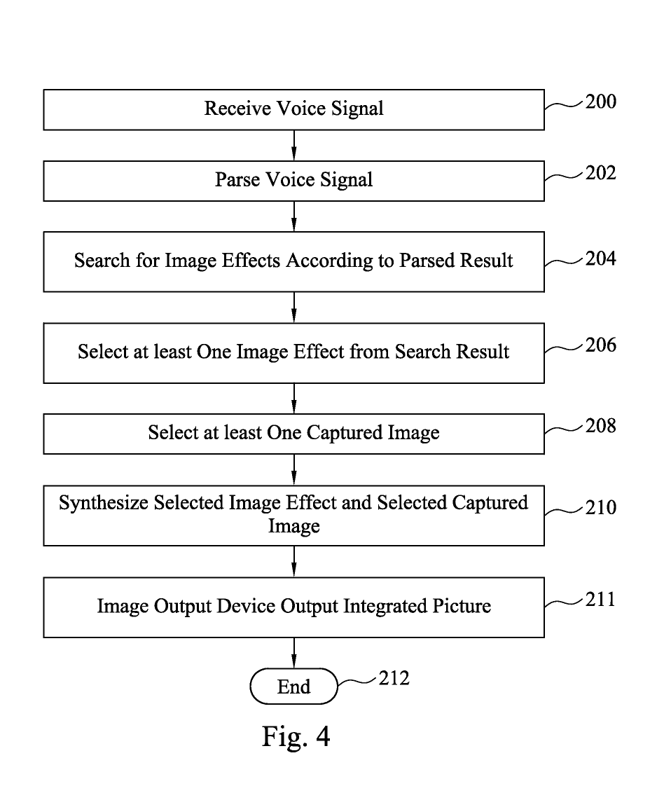

FIG. 4 is a flow chart of the method for image processing by voice recognition according to another embodiment of this invention. The method here is similar to the aforementioned embodiment, the only difference is that the method for image processing by voice recognition further includes step 211: providing the image output device 20, and when the image capture device 12 instructs the image output device 20 to output the synthesized image, the image output device 20 outputs the synthesized picture. The synthesized picture includes the picture base printed according to the captured image and the picture effect printed according to the special mark.

By integrating voice recognition and the image capture device 10, the user can easily post-process images after taking pictures in situations such as traveling or gathering. In addition, when the image capture device 10 is used with an instant mobile printer, in which the process from photographing to printing photos becomes more complex, the image capture device 10 still provides the best user experience by reducing the cumbersome operation process.

Although the present invention has been described in considerable detail with reference to certain embodiments thereof, other embodiments are possible. Therefore, their spirit and scope of the appended claims should no be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An image capture device, comprising:
a memory module storing a plurality of image effects;
an image capture module for capturing and generating a captured image and then storing the captured image in the memory module;
a voice recognition module for receiving a voice signal; and
a controller electrically connected to the memory module, the image capture module, and the voice recognition module, wherein the controller parses the voice signal via the voice recognition module, and is connected to the memory module to searches at least one of the image effects according to a parsed result, and selects a desired one of the image effects from the at least one of the image effects, and then the controller is connected to the memory module to select the captured image, and synthesizes the selected image effect with the captured image.

2. The image capture device of claim 1, wherein the controller synthesizes the selected image effect with the captured image by layer overlay.

3. The image capture device of claim 1, wherein the controller synthesizes the selected image effect with the captured image by labeling the selected image effect as a special mark in the captured image, thereby forming a synthesized image.

4. An image processing system, comprising:
an image capture device of claim 3;
an image output device, wherein when the image capture device instructs the image output device to output the synthesized image, the image output device outputs a synthesized picture, the synthesized picture comprises a picture base printed according to the captured image and a picture effect printed according to the special mark.

5. The image processing system of claim 4, wherein a color of the picture effect is a metallic color.

6. A method for image processing by voice recognition, the method comprising:
receiving a voice signal by a voice recognition module;
parsing the voice signal by the voice recognition module and a controller;
connecting the controller to a memory module, and searching at least one of image effects according to a parsed result by the controller;
selecting a desired image effect from the at least one of the image effects;
connecting the controller to the memory module, and selecting at least one captured image by the controller; and
synthesizing the selected image effect with the selected captured image by the controller.

7. The method of claim 6, wherein the controller synthesized the selected image effect with the selected captured image by layer overlay.

8. The method of claim 6, wherein the controller synthesizes the selected image effect with the selected captured image by labeling the image effect as a special mark in the captured image, thereby forming a synthesized image.

9. The method of claim 8, further comprising:
providing an image output device, wherein when the image capture device instructs the image output device to output the synthesized image, the image output device outputs a synthesized picture, wherein the synthesized picture comprises a picture base printed according to the captured image and a picture effect printed according to the special mark.

10. The method of claim 9, wherein a color of the picture effect is a metallic color.
